(19) United States
(12) Patent Application Publication
(10) Pub. No.: US 2021/0051847 A1
(43) Pub. Date: Feb. 25, 2021

(54) DAMP SAND HOPPER SYSTEM

(71) Applicant: DryJect Inc. Acquisition Corp., Hatboro, PA (US)

(72) Inventors: John Paddock, Hainesport, NJ (US); Matt Majernik, Croydon, PA (US)

(73) Assignee: DryJect Inc. Acquisition Corp., Hatboro, PA (US)

(21) Appl. No.: 17/001,613

(22) Filed: Aug. 24, 2020

Related U.S. Application Data
(60) Provisional application No. 62/890,969, filed on Aug. 23, 2019.

(51) Int. Cl. A01C 23/02; A01G 20/30; A01B 45/00

(52) U.S. Cl. CPC A01C 23/028; A01B 45/00; A01G 20/30

(57) ABSTRACT

A towable or self-propelled device and method for treating and maintaining turf are disclosed. These include at least one roller and manifold assembly, said at least one roller and manifold assembly including a plurality of injection heads for directing periodic high pressure jets of liquid and at least one additive material into the ground, said jets of liquid having a discrete pulse duration, wherein the depth of penetration of the jets into the soil is a function of the pulse duration, wherein said plurality of injection head creates a discharge pattern greater than 30 inches in width and at least 1 inch in depth; a liquid supply system for supplying pressurized liquid to said at least one injection head; an additive supply system for introducing said at least one additive material to said liquid within said at least one injection head, the additive supply system including a hopper that receives the additive material after passing through a plurality of sifters; and a control system for controlling discharge from said at least one injection head.

### CROSS REFERENCE TO RELATED APPLICATIONS

This application claims the benefit of U.S. Provisional Patent Application No. 62/890,969 entitled DAMP SAND HOPPER SYSTEM filed Aug. 23, 2019, with inventors John Paddock and Matt Majernik, which application is incorporated by reference as if fully set forth.

### FIELD OF INVENTION

The present invention is directed to natural turf, ornamental landscaping and soil maintenance, and more specifically, to a damp sand hopper system, device and method.

### BACKGROUND

Turf and soil maintenance, for those involved in the golfing industry and turf grass management, for example, plays a critical role in the success of a business. The greens and fairways provide the surface where golfers spend the majority of their time. Proper treatment and maintenance of that surface creates a higher quality product, and provides for a more aesthetically appealing landscape, which creates a highly attractive and desirable course for play.

The introduction of various materials, such as soil amendments, fertilizers, pesticides, and other additives, as well as the process of aeration, may improve the properties of the soil and the growth it supports. Aeration, for example, may be used to control compaction, soil temperature, regulate soil moisture, improve drainage, stimulate microbial activity and improve overall soil health. Timely aeration improves soil texture, and, through the incorporation of certain physical additives or biologicals, may prevent soil from becoming compacted, which impedes overall plant health, seed germination, root growth, and water transmission.

The time involved in maintaining ground surfaces may also be detrimental to the enjoyment of those surfaces. On a golf course, for example, golf play usually drops off significantly after historical, disruptive aeration, as more experienced golfers may inquire about the aeration schedules, and avoid those times. This may result in lost revenue. Labor costs of cleanup, such as the cleanup of the plugs, spreading of soil amendments and topdressing may be very high.

Historically, the introduction of materials to the soil surface or subsurface was accomplished through use of tillage tools that cut or plow the surface and release the additives into the openings created. While this technique may work for industries such as farming, the amount of soil eruption and surface disturbance is unacceptable for golf courses and other landscapes that have value in their visual appeal.

Other methods have also been used, such as core aeration, which is also disruptive to the ground surface. Alternatively, techniques such as injection of liquid substances into the subsurface using high pressure water jets, may not be as disruptive to the ground surface, but may be limited to the use of liquid or wet additive materials. Injection of dry materials may also not be as disruptive, but may be limited to the use of dry materials. Additionally, these other methods may involve machinery and materials that are more expensive and require more time, thus increasing the total costs involved in the treatment and maintenance of the ground surface.

### SUMMARY

A towable or self-propelled device and method for treating and maintaining turf are disclosed. These include at least one roller and manifold assembly, said at least one roller and manifold assembly including a plurality of injection heads for directing periodic high pressure jets of liquid and at least one additive material into the ground, said jets of liquid having a discrete pulse duration, wherein the depth of penetration of the jets into the soil is a function of the pulse duration, wherein said plurality of injection head creates a discharge pattern greater than 30 inches in width and at least 1 inch in depth; a liquid supply system for supplying pressurized liquid to said at least one injection head; an additive supply system for introducing said at least one additive material to said liquid within said at least one injection head, the additive supply system including a hopper that receives the additive material after passing through a plurality of sifters; and a control system for controlling discharge from said at least one injection head.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 illustrates a view of the device of the present invention;

FIG. 2 illustrates a view of the device including the internals of the hopper;

FIG. 3 illustrates a side of the device of the present invention;

FIG. 4 illustrates a top view of the hopper of the present invention; and

FIG. 5 illustrates an external view of the present invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical turf and soil management systems and methods of using the same. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

According to an aspect of the present invention, a substance, such as a liquid, solid or air, may be used to effectively drill a hole in the soil. This hole may have a diameter in the range 0.1 to 2.0 inches. Substantially simultaneously, the created hole may be filled with a soil amendment. Upon filling, the surface of the soil is left substantially smooth, with minimal soil disruption and displacement.

Additives may be injected, such as by a vacuum created through the Venturi Effect, where the substance fires and the additive may be sucked into the injection stream. Since this occurs after the injection port, many dry and/or liquid materials may be added into the stream, including: sand top dressing; diatomaceous earth; calcined clay; seed; insecticides; herbicides; fungicides; biologics; and root stimulants, by way of non-limiting example only.

According to an aspect of the present invention, the present device and system may be used to relieve stress in the soil, such as a golfing green. The device may also provide deep penetration of additives into the soil. Such access may be as great as 12 inches in depth. The description included within U.S. Pat. No. 7,581,684 is incorporated by reference as if fully set forth.

The device according to an aspect of the present invention may be used to punch through sod to give roots deep access; punch through a fiber or stabilized sports turf to allow better root proliferation below a mesh; aerate, amend and top-dress in one pass and allow for play on a smooth surface in approximately one hour.

The method and device described herein may provide a way of successfully placing granular materials, including dry and damp granular materials, into the ground without mechanically penetrating the soil with a solid tool of some type. The jets, using water or air blasts, may carry the material into the soil and leave no eruption on the surface to interfere with any immediately following activities or other treatments. This may be particularly beneficial where the particles are being added to lawns, putting greens and fairways on golf courses, sports fields and the like.

The present invention may provide a way of more accurately achieving the application rate selected for the particular aeration. Instead of setting the nozzles to fire at certain time intervals and similarly controlling the metering of dry, damp, and wet materials to the nozzles, the present invention fires its nozzles as a function of the distance traversed by the device along its path of travel. A certain firing rate as a function of the distance traveled may be programmed into the device. Thus, until the device travels its pre-set distance, the next blast from the nozzles may not occur, regardless of whether the device travels quickly or slowly over such distance. In other words, although the spacing between slots may be adjusted by the operator, once a selection is made, that spacing (from the beginning of one slot to the beginning of the next slot) remains substantially fixed.

The present invention utilizes a method for mixing a particulate matter, in granulated dry, damp or wet form, with a driving liquid into a ground surface or otherwise aerating a ground surface with a combination of air and a driving liquid. An exemplary use of such a method may be found in U.S. Pat. No. 5,370,069 to Monroe, the entire disclosure of which is incorporated in its entirety by reference herein.

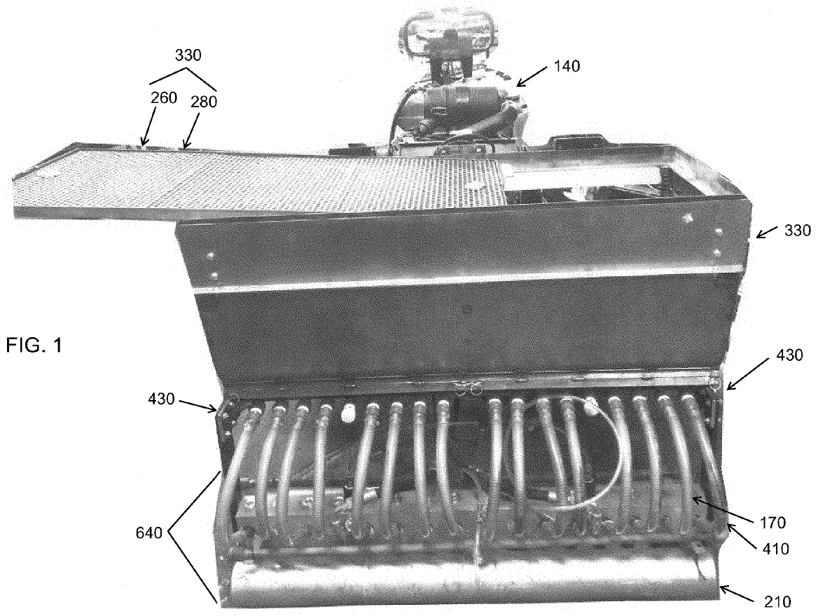

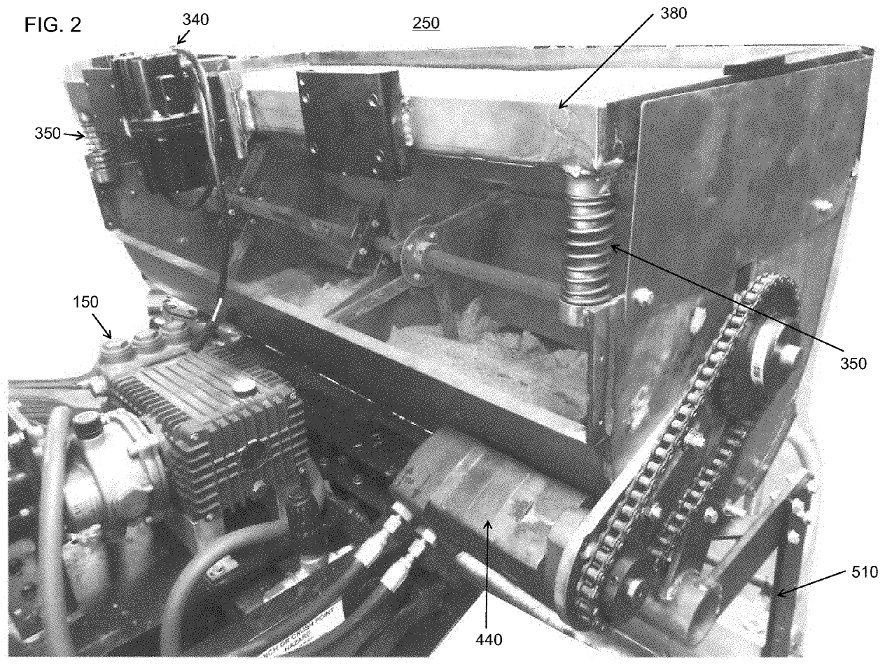

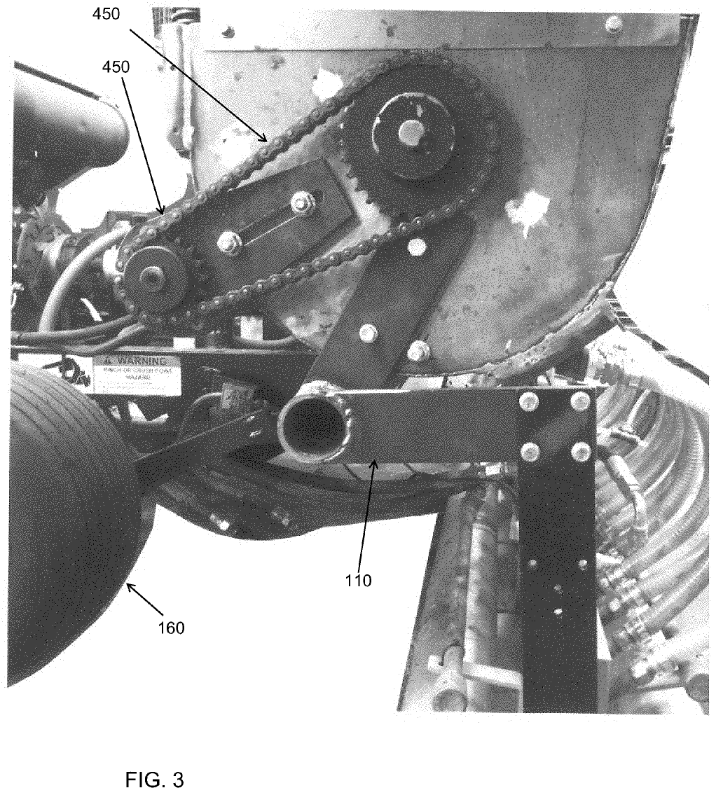

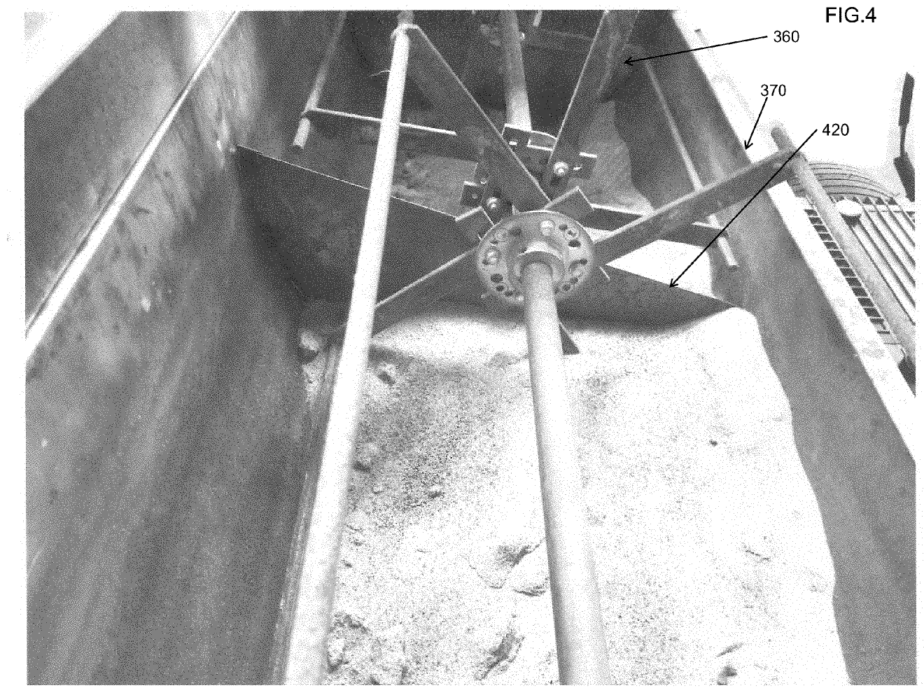

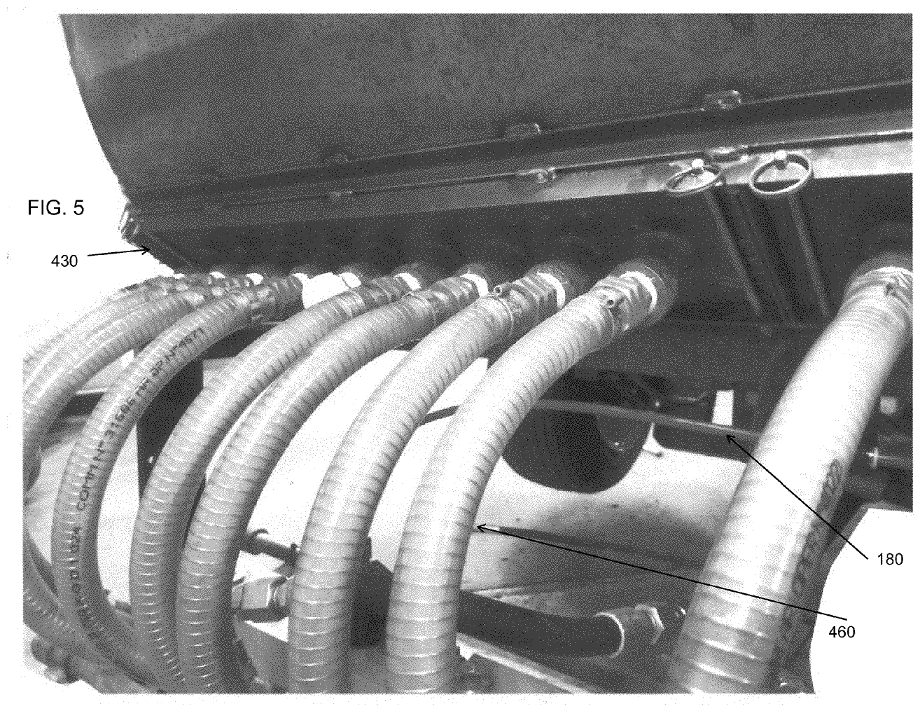

The figures collectively illustrate a device 100 for substantial non-disruptive delivery of dry or wet material into the soil subsurface. FIG. 1 illustrates a view of the device of the present invention. FIG. 2 illustrates a view of the device including the internals of the hopper. FIG. 3 illustrates a side of the device of the present invention. FIG. 4 illustrates a top view of the hopper of the present invention. FIG. 5 illustrates an external view of the present invention. These figures are used collectively to illustrate device 100 and its various components. Referring collectively to FIG. 1, FIG. 2, FIG. 3, FIG. 4 and FIG. 5 to describe device 100.

Device 100 may include a frame 110, at least one battery (not shown), at least one accumulator tank (not shown), at least one engine 140 or motor, at least one pump 150, at least two ground wheels (not shown), at least one roller and manifold assembly 170, and an axle 180. As may be seen in the figures, frame 110 may provide the structure of device 100 which holds battery, at least one accumulator tank, engine 140, at least one pump 150, and at least one roller and manifold assembly 170, while being supported by at least two ground wheels interconnected by axle 180.

Device 100 may be designed to be pulled or towed by any piece of equipment known to those possessing an ordinary skill in the pertinent arts. Such pulling or towing equipment include, but are not limited to, tractors, golf carts, and automobiles. Alternatively, the device 100 may be a self-propelled device.

Device 100 may include a frame 110, ground wheels and sensor wheel. Sensor wheel may be located at one end of frame 110. Ground wheels may be connected by a transverse axle 180 or shaft rotatably coupled to frame 110, as would be evident to one possessing an ordinary skill in the pertinent arts. Ground wheels and axle 180 may be elevated relative to frame 110 or the manifold roller assembly may be moved independently to enable at least one roller and manifold assembly 170 to engage the ground, or other surface on which device 100 rests. Ground wheels and axle 180 may be lowered relative to frame 110 to permit transport of device 100 on ground wheels. Ground wheels and axle 180 may be rigidly attached relative to frame 110, while at least one roller and manifold assembly 170 rotates to engage the ground. A pair of spaced apart, transversely disposed pressing rollers may be included within at least one roller and manifold assembly 170.

Several systems which make up the operating components of the device 100 may be carried by frame 110. These systems may include an injection system included within at least one roller and manifold assembly 170, a water supply system (not shown), including at least one pump 240, an additive supply system 250, a screening system 260 and a control system (not shown).

The screening system 260 may include a multi-level, removable plurality of screens 280. These screens 280 may be designed to be configured in a decreasing mesh size. This may decrease as the soil amendment is added and eventually ends up in the hopper 310. The mesh may be designed to vibrate via a motor 340 at a high frequency to sift and separate amendments from debris and large aggregated pieces or groups of amendments before entering the main hopper 310. The main hopper 310 may be provided directly below the plurality of screens 280 allowing gravity to assist the amendment in the filtration and sifting, as well as accumulating in the hopper 310. The hopper 310 then holds the amendment prior to being drawn into the Venturi system 320, discussed herein below.

Specifically, there may be a vibrating sifter 330 that sits above the hopper 310 that separates any unwanted debris from the desired soil amendment. The sifter 330 may include a dual gradient, removable screen deck that sits and locks into the inside of a secondary frame encompassing the entire top of the hopper 310. A vibrating motor 340, such as an electric or hydraulic motor, is attached to the sifter frame 380. The sifter frame 380 rests on four springs 350, each located in a corner of the secondary frame to allow the vibrating motor 340 to efficiently sift and disseminate the amendment into the hopper 310. This process allows dry, damp, and wet sand to be utilized.

The hopper 310 may be designed to include a paddle system 360. This paddle system 360 may be initiated to keep the wet or dry amendment from clumping and bridging after it has been filtered and sifted. The paddle system 360 may also perform a mixing function. This mixing function may enable the full load of the amendment in a homogenous state, and may allow smaller volumes of amendment to be added mechanically or by hand to the full load. The smaller volumes may include additives, such as fertilizers, seed, super absorbent polymers (SAP), and various organic amendments.

In an aspect, the hopper 310 may be formed from one half drum that sits directly below the vibrating sifter 330. The drum may be a drum of a diameter from 18-25 inches. More specifically, a drum approximately 19″ in diameter may be used. Within hopper 310 is an auger 370 that rotates at 10 to 20 RPM to keep the entire sand pile loose. Auger 370 keeps all of the amendment loose enough to be drawn into the injection manifold 410 by means of a Venturi vacuum. The auger 370 is turned using a hydraulic or electric motor 440 and a chain gear reduction 450. There is a divider 420 in the middle of the hopper 310 to keep the sand from migrating all to one side if operating on a slope. The rotation of the auger 370 also keeps sand directly in front of the Venturi suction ports.

Near the bottom of the hopper 310 are removable mounting plates 430. For example, two mounting plates may be used. These plates contain fittings onto which vacuum hoses 460 may be attached. The number of hoses that can be attached may vary by use and the use of the mounting plates 430 allows for addition or subtraction of vacuum hoses 460. The fittings on the mounting plates 430 may be positioned at an angle so that the amendment does not flow unrestricted down the vacuum tubes. This angle requires the amendment to be pulled into the tubes. The removable mounting plates 430 may allow for the hopper 310 to be emptied by being removed and allowing the amendment to fall out of the hopper 310.

In one example, two removable mounting plates may be used. These plates allow multiple amendment delivery line systems to be utilized. The plates sit at an angle (from the center point) off the bottom side of the hopper 310. There is a horizontal stop built into them to prevent amendment from filling the suction lines. This angle may be from 30-60 degrees, or in one embodiment approximately 45 degrees, for example. The angle is designed to prevent the filling of the suction lines, instead allowing the suction lines to pull the amendment into the lines. This enables the unit to be used with dry, damp, or wet sand. The removable plates allow for a fast and easy dumping and cleaning of the entire hopper 310 contents.

Roller and manifold assembly 170 may be disengaged and held above the ground surface, or may be engaged, where at least one roller and manifold assembly 170 may be supportive of frame 110, such that roller and manifold assembly 170 or assemblies and sensor wheel support frame, and ground wheels are lifted above the ground surface. Roller and manifold assembly 170 when disengaged may be held above and substantially perpendicular to the ground so that they may be easily accessed for cleaning and other handling and maintenance purposes. A plurality of hanger brackets 510 may support at least one roller and manifold assembly 170 to frame 110. Plurality of hanger brackets 510 may support a pair of bars, such as fore and aft, on opposite sides of at least one roller and manifold assembly 170. Bars may be configured to rotatably support pressing rollers on opposite, such as fore-and-aft, sides of injection head of at least one roller and manifold assembly 170. A cover, such as a skid plate, may span bars, adjacent to head and may be substantially rigidly fixed to bars. Cover may protect outlet cones of injection head from damage through impact with obstacles. At least one upstanding bracket 540 may be included to form a part of a sub-frame, which includes hanger brackets 510, bars and cover. At least one upstanding bracket 540 may be substantially fixedly attached to portions injection head to thereby fixedly secure injection head to hanger brackets 510.

Device 100 may include at least one manifold 610, engine 140, accumulator, pump 150 and control panel to maximize the speed and area covered. According to an aspect of the present invention, three manifold assemblies, two engines, three accumulators, two pumps, and one control panel may be used. The three roller and manifold assemblies may be aligned forming a roller and manifold assembly 170 pattern. This pattern may be any width. For example, the width may be 60-120 inches, or more specifically in one embodiment, approximately 90 inches. The width of the roller and manifold assembly 170 pattern may vary, according to the number and size of the roller and manifold assemblies 170 used in any particular embodiment of the present invention. In order to form this large of an assembly pattern, each individual roller may be staggered with respect to at least the adjacent roller. Such a configuration may permit better access to at least one roller and manifold assembly 170, such as for purposes of maintenance. The staggered roller and manifold configuration may aid in keeping the injection hole spacing even through the total width of the device 100. The staggered positioning may, of course, vary depending on the size and number of roller and manifold assemblies 170 utilized, as well as according to the hole spacing expected or required. The individual manifolds 610 within manifold assembly 170 may be designed to individually free float and articulate to thereby enable individual manifolds 610 to better match the contours of the ground, for example.

Injection head may include a block-like, transversely extending manifold and a series of tubular discharge cones projecting from the bottom of manifold. According to an aspect of the present invention, thirty cones may be utilized. But it may be understood that greater or fewer numbers of cones may be utilized without departing from the principles of the present invention. Manifold 610 may include a set of longitudinally extending, parallel cross-drill passages. For example, three such passages, each extending substantially horizontally through block at substantially different levels. Passages have not been illustrated as extending entirely through the block from end-to-end and then closed at such opposite ends by suitable plugs as may be the case in commercial practice. Passage may be located at the highest level of the three passages, while passage may be located a short distance below passage in laterally spaced relation thereto, while passage may be located below passage in the same vertical plane as passage, for example.

Device 100 may include a water inlet. Inlet may be designed to input water into device 100 such as by a hose, for example. Inlet may be designed to be accessible from either side of device 100. Device 100 may include multiple inlets accessible from either side of device 100 so that water may be input to device 100 on one side while progressing in one direction and then input on the other side after turning around and moving back in the other direction. Such a feature may permit the user to more easily maneuver device 100.

Substantially extending vertically through manifold 610 may be nozzle passage which may take the form of a single or multiple set of passages that may be identical. According to an aspect of the present invention, sixteen nozzle passages may be used. Other nozzle arrangements or quantities of nozzles may be used as would be understood that six nozzle configurations are just a single, specific example. Nozzle passage may intersect passage such that high pressure liquid supplied to passage may also be communicated to nozzle passage. A series of plugs, such as an Allen head plug, may be threaded into the upper ends of nozzle passages to close off the upper ends of the passages during operation.

Mixing chamber within nozzle passage may be enlarged with respect to restricted nozzle upstream therefrom so as to create a Venturi Effect in each passage at mixing chamber. Such a Venturi Effect may create an area of negative pressure within mixing chamber to induce a secondary air stream into mixing chamber via an inclined supply passage. Inclined supply passage may be coupled with an additive supply hose as shown, for example. Supply passages and supply hoses may include a portion of the additive supply system 250 of the present invention.

A control panel associated with device 100 according to an aspect of the present invention. Device 100 may include a control panel for control of device 100. Control panel may have control switches, such as for injection, water pressure, depth control, spacing control, additive, and power to device 100, for example. Control panel may also provide sensory information, such as over speed and water pressure, for example.

Control panel may monitor the speed of wheel and appropriately fire injectors of manifold assembly or assemblies at the appropriate time and rate to thereby control the rate of additive insertion. Panel may monitor a signal generated by the sensor in wheel. Responsive to the signal, control panel may activate a low-pressure switch associated with water pump and a lift switch associated with the injection head or heads of manifold assembly or assemblies. Control panel may control the solenoid, water pump clutch, and motor responsive to the signal. Control panel may be programmable. Further, control panel may be programmable in the field, or on-site, for example. Such programming may be suitable for effecting the spacing and depth or aeration for example.

Control panel may provide an interface for turning power on and off, controlling the depth of the injection, controlling the spacing of the injections, controlling the volume of the additive, and raising and lowering of injection head or heads, for example. Control panel may provide indication of the status of device 100 including power on, injection spacing, additive volume, injector firing, over speed, such as by light and horn, speed warning, and low water pressure. Control panel may control mixing as described above and may include control of a mini-hopper. Control panel may control engine 140 RPM and battery voltage. For example, the speed sensor may be connected such that a signal indicative of the speed of device 100 is provided. As may be known to those possessing an ordinary skill in the pertinent arts, speed indication may be performed, for example, by utilizing a disc with holes on a movable wheel, sensor, for example, and by producing a signal proportional to the variation in magnetic field as holes in the disc move past the speed sensor a in coordinated movement with device 100. Further, a disc having a plurality of holes may be utilized with wheel or any circumference. In a specific configuration a 100 holes may be used. Alternatively, 36 holes may be used with a matched wheel circumference of 36 inches. Such a configuration may provide one hole of sensing per inch of travel. Other configuration may suitably be used, as would be evident to those possessing an ordinary skill in the pertinent art, to provide greater speed sensitivity. Alternatively, an infrared sensor or reader may be used as would be known in those skilled in the art for indicating the speed of device 100. Also, a low-pressure switch may be activated when the incoming water pressure drops below a preset level.

A controller, integral to control panel, may include a suitable programmable computer. Controller may be housed within control panel and may receive input from various components of device 100 and may provide output to operating components of device 100. Solenoid may be energized and de-energized by controller. In determining when to cause operation of solenoid, controller may receive inputs from sensor wheel.

Control of the injection process may be accomplished through a control panel, which may be attached to the device 100. Control panel may control the multiple poppet valves through a speed sensor that is integral to the hydraulic or electric wheel drive. The wheel may be raised in transport and lowered to the ground when in use. Sensor wheel may also act as a dolly wheel for the device 100.

Selector switch for selecting different spacing between the slots formed in the ground by the jets from device 100 may be provided. Spacing may cause controller to maintain the selected spacing distance between the starting points of successive slots. For example, one choice may be a spacing of 1.5 inches from the starting point of one slot to the starting point of the next slot, another choice might be 3.0 inches between starting points, a third choice might be 4.5 inches between starting points, and a fourth choice might be 6.0 inches.

Depth selector may be provided on control panel to provide an input to controller. Depth selection may be placed in one of several different positions which establishes the duration of blast time from device 100. When device 100 is stationary, the duration of blast time may have a direct relationship with the depth of the hole formed in the soil, while when device 100 is moving along its path of travel the duration of the blast may affect not only the depth of the resulting slot but also the length of the slot. Thus, the “depth” selected may determine the total volume of the opening or slot produced in the soil by the jet when device 100 is in motion.

In carrying out the injections, the water and additive material first come into contact with one another within mixing chamber below each nozzle. As each nozzle fires, its powerful jet of water rushing through mixing chamber may induce a secondary air-stream within the corresponding additive hose, drawing the minute, accumulated charge of material into mixing chamber to be incorporated into the water jet. During the short pause between successive jets from each nozzle, enough material may have accumulated a minute charge of material in accumulating chamber in preparation for the next blast from nozzles. Further, according to an aspect of the present invention, 1-12 cubic feet of additive material may be dispersed per one thousand square feet of soil or land covered depending on spacing and depth.

As illustrated, distribution manifold has a single, central inlet passage to which a hose is connected. A longitudinal distributing bore runs along the length of distribution manifold and receives liquid from inlet passage. A series of discharge nozzles may be connected with distribution bore and deliver pulses or increments of liquid into respective distribution hoses. Each of hoses is supported in a manner to produce a bight or bend so as to form an internal collecting chamber similar to the granular collecting chamber of the first embodiment. Thus, during each pulse or blast of the injection head an accumulated increment of additive is drawn into the injection head through each line and discharged along with the water jet out the discharge cone.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement the processes and methods described herein.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

What is claimed is:

1. A towable or self-propelled device for treating and maintaining turf, comprising:
at least one roller and manifold assembly, said at least one roller and manifold assembly including a plurality of injection heads for directing periodic high pressure jets of liquid and at least one additive material into the ground, said jets of liquid having a discrete pulse duration, wherein the depth of penetration of the jets into the soil is a function of the pulse duration, wherein said plurality of injection head creates a discharge pattern greater than 30 inches in width and at least 1 inch in depth;
a liquid supply system for supplying pressurized liquid to said at least one injection head;
an additive supply system for introducing said at least one additive material to said liquid within said at least one injection head, the additive supply system including a hopper that receives the additive material after passing through a plurality of sifters; and
a control system for controlling discharge from said at least one injection head.

2. The device of claim 1, further comprising a hinging mechanism, wherein said hinging mechanism positions said at least one roller and manifold assembly in contact with the ground surface when said at least one roller and manifold assembly is engaged, and positions said at least one roller and manifold assembly above the ground surface when said at least one roller and manifold assembly is not engaged.

3. The device of claim 1, wherein said discharge pattern is greater than 75 inches in width.

4. The device of claim 1, wherein said liquid supply system comprises at least one high pressure pump for supplying pressurized liquid to said at least one injection head.

5. The device of claim 1, wherein said at least one injection head comprises a nozzle connected with said liquid supply system for producing a jet of liquid when pressurized liquid is supplied to said nozzle, an outlet for the liquid jet downstream from said nozzle, and a mixing region between said nozzle and said outlet.

6. The device of claim 5, wherein said mixing region comprises an inlet connected with said additive supply system for admitting said at least one additive material to said mixing region for combination with the liquid jet produced by said nozzle.

7. The device of claim 6, wherein said at least one injection head further comprises a venturi for creating negative pressure with said mixing region to draw said at least one additive material through said inlet as the jet is discharged from said outlet.

8. The device of claim 1, wherein said control system comprises a controller, a distance sensor operable to provide ground traversing distance information to said controller, and a valve operable by said controller to admit successive bursts of pressurized liquid into said at least one injection head as a function of said distance information provided to said controller by said distance sensor.

9. The device of claim 8, wherein said controller further comprises a programmable computer.

10. The device of claim 9, wherein said controller further comprises means for selectively adjusting distance intervals between successive operations of said valve.

11. The device of claim 10, wherein said controller further comprises means for selectively adjusting the duration of each operation of said valve.

12. The device of claim 11, wherein said discharge pattern from said at least one injection head is related to the ground traversing distance while the device is moving along a path of travel.

13. The device of claim 1, wherein said additive supply system is suitable for delivering 1 to 10 cubic feet of said at least one additive material in granular form subsurfacely to 1000 square feet of soil or land.

14. The device of claim 1, wherein said additive supply system is suitable for delivering said at least one additive material in liquid form to said at least one injection head.

15. The device of claim 1, wherein said additive supply system further comprises a collecting chamber disposed to receive said at least one additive material, and to accumulate successive charges thereof.

16. The device of claim 15, wherein said injection head communicates with said collecting chamber, and wherein said additive supply system provides means for drawing the accumulated charge of said at least one additive material into the liquid jet during each discharge from said at least one injection head.

17. The device of claim 15, wherein said collecting chamber having an entrance thereto, said additive supply system being operable to deliver said additive material to said entrance substantially continuously during intermittent discharges of jets from said injection head.

18. A method of treating and maintaining turf, comprising:
producing successive high pressure jets of pressurized liquid;
directing said successive jets of pressurized liquid toward the ground creating a distribution pattern greater than 30 inches in width and at least 1 inch in depth along a path of travel, wherein said successive jets of pressurized liquid are at spaced intervals along said path of travel, and wherein the jets' depth of penetration into the soil is a function of the jets' pulse duration;
producing successive charges of at least one additive material;
maintaining each charge of said at least one additive material isolated from the liquid until a corresponding jet has been produced, the additive material isolated in a hopper that receives the additive material after passing through a plurality of sifters; and
introducing a charge of said at least one additive material into said corresponding jet as said corresponding jet is directed toward the ground.

19. The method of claim 18, wherein said spaced intervals are a function of distance traversed along said path of travel.

20. The method of claim 18, further comprising adjusting distance intervals between said successive jets of pressurized liquid along said path of travel.

21. The method of claim 18, further comprising adjusting the duration of said successive jets of pressurized liquid.

22. The method of claim 18, wherein said producing successive charges of said at least one additive material comprises adjusting the rate of production of said charges as a function of distance traversed along said path of travel.

23. The method of claim 18, wherein said directing said successive jets of pressurized liquid toward the ground comprises producing a region of negative pressure in association with said successive jets of pressurized liquid.

24. The method of claim 23, wherein said introducing a charge of said at least one additive material into said corresponding jet comprises drawing said charge of said at least one additive material into said corresponding jet using said region of negative pressure.

25. The method of claim 18, wherein said producing successive charges of said at least one additive material includes delivering said at least one additive material in a steady stream to a collecting chamber while said successive jets of pressurized liquid are produced intermittently.

26. The method of claim 25, wherein said introducing a charge of said at least one additive material into said corresponding jet includes drawing each charge out of said collecting chamber and into said corresponding jet.

27. The method of claim 26, wherein said delivering said at least one additive material to said collecting chamber in a steady stream includes adjusting the rate of delivery to said collecting chamber as a function of the distance traversed along said path of travel.

28. The method of claim 27, wherein directing successive jets of pressurized liquid into the ground occurs while said successive jets of pressurized liquid are in motion along said path of travel.
